(19) United States
(12) Patent Application Publication
(10) Pub. No.: US 2017/0144700 A1
(43) Pub. Date: May 25, 2017

(54) HYDRAULICALLY ASSISTED STEERING SYSTEM

(71) Applicant: TRW Automotive U.S. LLC, Livonia, MI (US)

(72) Inventor: Amine Nhila, Lafayette, IN (US)

(21) Appl. No.: 14/946,819

(22) Filed: Nov. 20, 2015

(51) Int. Cl. B62D 5/12; B62D 6/00; B62D 5/08

(52) U.S. Cl. CPC B62D 5/12; B62D 5/08; B62D 6/00

(57) ABSTRACT

A hydraulically assisted steering system comprises a steering gear operatively connected to a steering wheel and to a set of steerable wheels to effect turning of the steerable wheels in response to rotation of the steering wheel. A hydraulic motor is operatively connected to the set of steerable wheels to assist in turning of the steerable wheels. A pump is fluidly connected to the hydraulic motor to deliver a flow of fluid to the hydraulic motor via a flow path from the hydraulic pump to the hydraulic motor. The flow path from the hydraulic pump to the hydraulic motor is free of any rotary steering control valve. Pressure control apparatus monitors and adjusts hydraulic fluid pressure in the hydraulic motor. The pressure control apparatus adjusts hydraulic fluid pressure in the hydraulic motor by controlling one of pump speed and pump displacement. Direction control apparatus controls direction of hydraulic fluid flow to the hydraulic motor.

### TECHNICAL FIELD

The present invention relates to a hydraulically assisted steering system.

### BACKGROUND OF THE INVENTION

In a known power steering system, a steering wheel is mechanically connected to a steering gear. The steering gear includes a rotary steering control valve in which a valve core and a coaxial valve sleeve are rotatable relative to one another. Rotational movement of the steering wheel is transmitted via a mechanical linkage to the rotary steering control valve of the steering gear. In response, the valve core and the valve sleeve rotate relative to one another to direct hydraulic fluid provided by a pump toward and away from chambers in a hydraulic motor.

Relative movement of the valve core and valve sleeve in one rotational direction directs high pressure fluid from the pump through the steering control valve into a first chamber of the hydraulic motor and directs fluid away from a second chamber of the hydraulic motor through the steering control valve to a reservoir. In response to the fluid flows, a piston disposed between the chambers in the hydraulic motor moves in a first axial direction to assist turning of steerable vehicle wheels in one direction. Relative movement of the valve core and valve sleeve in an opposite rotational direction directs high pressure fluid from the pump through the steering control valve into the second chamber of the hydraulic motor and directs fluid away from the first chamber of the hydraulic motor through the steering control valve to the reservoir. In response to the fluid flows, the piston in the hydraulic motor moves in a second, opposite axial direction to assist turning of the steerable vehicle wheels in an opposite direction.

As the valve core and valve sleeve of the rotary steering control valve rotate relative to one another, fluid flow passages between lands formed in the valve core and the valve sleeve are opened and closed. Because the rotary steering control valve is mechanically linked to the steering wheel, relatively small and/or slow rotational movements of the steering wheel partially open and partially close different fluid flow passages, but do not fully open or fully close the fluid flow passages. Fluid flow through the valve is thus restricted or throttled by the partially open and partially closed fluid flow passages. As a result, the rotary steering control valve in the steering gear controls changes in the axial direction in which the piston of the hydraulic motor moves, as well as and changes in the pressure in the opposed chambers of the hydraulic motor, but does so at the cost of energy losses from the power steering system due to throttling of the fluid flows.

### SUMMARY OF THE INVENTION

In a representative embodiment of the present invention, a hydraulically assisted steering system for turning vehicle steerable wheels comprises a steering gear operatively connected to a steering wheel and to a set of steerable wheels to effect turning of the steerable wheels in response to rotation of the steering wheel. A hydraulic motor is operatively connected to the set of steerable wheels to assist in turning of the steerable wheels. A hydraulic pump is fluidly connected to the hydraulic motor to deliver a flow of pressurized fluid to the hydraulic motor via a flow path from the hydraulic pump to the hydraulic motor. The flow path from the hydraulic pump to the hydraulic motor is free of any rotary steering control valve. Pressure control apparatus monitors and adjusts hydraulic fluid pressure in the hydraulic motor. The pressure control apparatus adjusts hydraulic fluid pressure in the hydraulic motor by controlling one of pump speed and pump displacement. Direction control apparatus controls direction of hydraulic fluid flow to the hydraulic motor.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic view of a steering system constructed in accordance with an example embodiment of the present invention; and

FIG. 2 is a schematic view of a steering system constructed in accordance with a second example embodiment of the present invention.

### DETAILED DESCRIPTION OF EMBODIMENTS

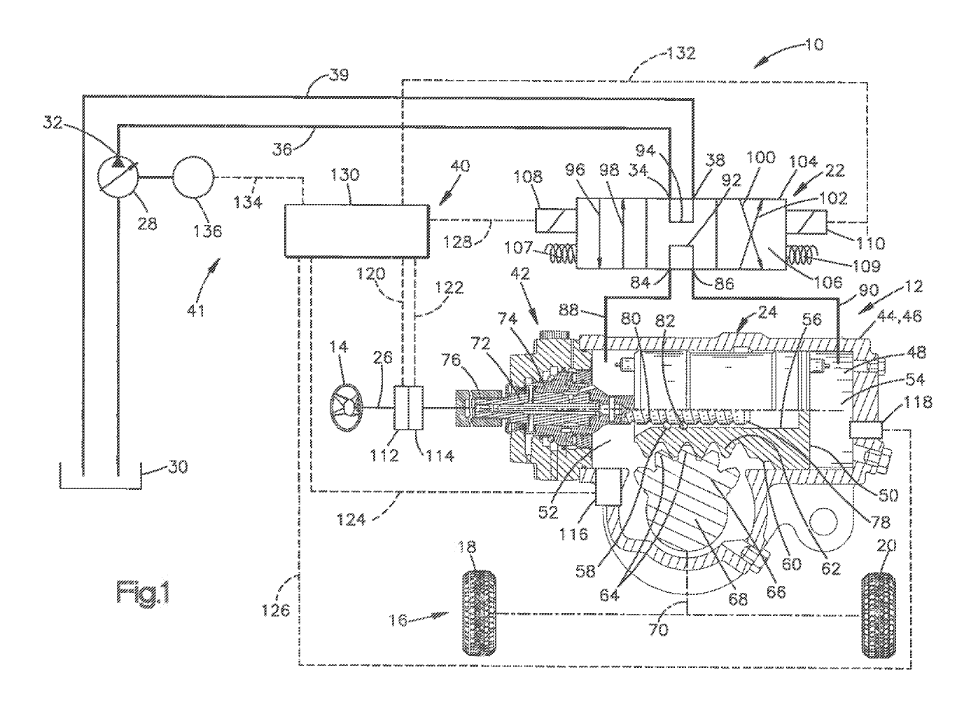

FIG. 1 illustrates a hydraulically assisted steering system 10 for a vehicle (not shown), in accordance with an example of the present invention. The hydraulically assisted steering system 10 comprises a hydraulic power steering gear 12 operatively connected to a manually rotatable vehicle steering wheel 14. The steering gear 12 is also operatively connected to a set 16 of steerable vehicle wheels 18 and 20. The steering gear 12 includes a hydraulic actuator or hydraulic motor 24. The vehicle steering wheel 14 is connected to the steering gear 12 through a rotatable steering column assembly 26.

A pump 28 delivers pressurized hydraulic fluid to the steering gear 12 from a fluid reservoir 30 via a direction control valve 22. The pump 28 may be a variable speed pump and/or a variable displacement pump, such as a piston pump with a swash plate. A fluid outlet 32 of the pump 28 is fluidly connected to or in fluid communication with a fluid inlet 34 of the direction control valve 22 by a fluid supply conduit 36. The pump 28 is continuously operated, at least during operation of the vehicle engine (not shown). Therefore, during operation of the vehicle engine (not shown), the pump 28 continuously supplies fluid under pressure to the direction control valve 22. A fluid outlet 38 of the direction control valve 22 is fluidly connected or connected in fluid communication with the reservoir 30 by a fluid return conduit 39.

The direction control valve 22 is a three position valve. One of the three positions is a “neutral” position, which is illustrated in FIG. 1. In the neutral position of the direction control valve 22, fluid from the pump 28 is delivered to or received at the fluid inlet 34 of the direction control valve 22 and is discharged at the fluid outlet 38 of the direction control valve to return or flow back to the reservoir 30. In the other two positions of the direction control valve 22, fluid from the pump 28 is directed through the direction control valve to the steering gear 12 and fluid from the steering gear is returned through the direction control valve to the reservoir 30. The direction control valve 22 is one component of a direction control apparatus 40, which operates in a manner that will be described in greater detail below.

The steering gear 12 is an integral hydraulic power steering gear that incorporates the hydraulic motor 24. The steering gear 12 may or may not incorporate some or all of the structural or mechanical components of a rotary steering control valve 42. Whether the steering gear 12 includes all, some, or none of the mechanical components of a rotary steering control valve 42, however, no fluid flows across or through the rotary steering control valve from the pump 28 to the hydraulic motor 24 or from the hydraulic motor to the pump. All fluid flow to and from the hydraulic motor 24 occurs through the direction control valve 22, and any fluid flow that might otherwise occur between the hydraulic motor and the steering control valve is blocked. As illustrated in FIG. 1, the steering gear 12 incorporates all of the components of a rotary steering control valve 42. The rotary steering control valve 42 is constructed as an open center valve.

The steering gear 12 includes a housing 44 that forms a hydraulic cylinder 46. The hydraulic cylinder 46 defines an internal chamber 48 that receives a piston 50. The piston 50 divides the chamber 48 into a first chamber portion 52 and a second chamber portion 54. Together, the hydraulic cylinder 46 and the piston 50 comprise the hydraulic motor 24.

The piston 50 includes an inner surface 56 that defines a bore extending axially into the piston from one end. The inner surface 56 includes a helical groove 58. The piston 50 also has an external surface 60 that includes a set of external teeth 62. The teeth 62 mesh with teeth 64 on a sector gear 66. The sector gear 66 is fixed to an output shaft 68, which extends outwardly from the housing 44. The output shaft 68 is connected to a pitman arm (not shown) which, in turn, is connected via a linkage 70 to the set 16 of steerable vehicle wheels 18 and 20 to steer the vehicle (not shown). As the piston 50 moves in the chamber 48, the output shaft 68 is rotated to operate the linkage 70, which turns the steerable vehicle wheels 18 and 20.

The rotary steering control valve 42 comprises first and second valve members. The first valve member comprises a rotatable valve core 72. The second valve member comprises a rotatable valve sleeve 74. The valve core 72 is located coaxially within the valve sleeve 74 and is supported by the valve sleeve for limited rotation relative to the valve sleeve. The valve core is formed in one piece with a rotatable input shaft 76 of the steering gear 12.

As is also known in the art, the valve sleeve 74 is partially received within the bore of the piston 50. An outer surface 78 of the valve sleeve 74 includes a helical groove 80. The helical groove 80 of the valve sleeve 74 and the helical groove 58 of the piston 50 receive balls 82, which both mechanically connect the valve sleeve and the piston and also permit the valve sleeve to rotate relative to the piston. As a result, rotational movement of the valve sleeve 74 relative to the piston 50 produces axial movement of the piston in the cylinder 46. Conversely, axial movement of the piston 50 in the cylinder 46 produces rotational movement of the valve sleeve 74 relative to the piston.

The rotary steering control valve 42 is actuated by the rotatable steering column assembly 26, which is connected to the input shaft 76 of the steering gear 12. The rotatable steering column assembly 26 is rotated by the vehicle steering wheel 14. As is known in the art, rotation of the vehicle steering wheel 14 is transmitted via the steering column assembly 26 to the rotary steering control valve 42 to cause relative rotation of the valve core 72 and the valve sleeve 74. When the valve core 72 is rotated relative to the valve sleeve 74, however, no hydraulic fluid is ported through grooves (not shown) and associated passages (not shown) in the valve core and valve sleeve to or from the first and second chamber portions 52 and 54. Stated differently, the rotary steering control valve 42 is not fluidly connected to or in fluid communication with the hydraulic motor 24. Thus, as will be explained in greater detail below, the flow path from the hydraulic pump 28 to the hydraulic motor 24 does not include or is free of the rotary steering control valve 42.

One end portion (to the left, as viewed in FIG. 1) of the valve sleeve 74 includes first and second lugs (not shown) that are disposed in diametrically opposed cut-outs (not shown) in the valve core 72. After rotation of the valve core 72 through an angle of between 2° and 8° relative to the valve sleeve 74, in response to rotation of the vehicle steering wheel 14, the lugs of the valve sleeve 74 engage the cut-outs in the valve core to cause the valve sleeve to be rotated together with the valve core. Such rotation of the valve sleeve 74 together with the valve core 72 causes the piston 50 to move axially in the chamber 48 and, hence, allows for manual steering of the vehicle even if a loss in hydraulic fluid pressure has occurred.

As previously stated, the direction control valve 22 directs fluid from the pump 28 to the steering gear 12 and directs fluid from the steering gear to the reservoir 30. More particularly, the direction control valve 22 includes a first port 84 and a second port 86 that is spaced apart and separate from the first port. A first hydraulic motor conduit 88 extends from the first chamber portion 52 of the hydraulic motor 24 to the first port 84 of the direction control valve 22. A second hydraulic motor conduit 90 extends from the second chamber portion 54 of the hydraulic motor 24 to the second port 86 of the direction control valve 22.

When the direction control valve 22 is in its neutral position, as shown in FIG. 1, the first port 84 of the direction control valve is fluidly connected to or in fluid communication with the first hydraulic motor conduit 88. At the same time, the second port 86 of the direction control valve is fluidly connected to or in fluid communication with the second hydraulic motor conduit 90. The first and second ports 84 and 86 of the direction control valve 22 are fluidly connected to or in fluid communication with each other through a passage 92 in the direction control valve. Fluid in each of the first and second chamber portions 52 and 54, respectively, of the hydraulic motor 24 is free to flow between the first and second chamber portions through the passage 92 in the direction control valve 22. Also in the neutral position of the direction control valve 22, the fluid inlet 34 of the direction control valve is fluidly connected to or in fluid communication with the fluid outlet 38 of the direction control valve through a passage 94 in the direction control valve. Fluid supplied by the pump 28 to the fluid inlet 34 of the direction control valve 22 is directed through the passage 94 to the fluid outlet 38 of the direction control valve, from which the fluid is returned to the reservoir 30 through the fluid return conduit 39.

When the direction control valve 22 is in a first actuated position (not shown), the first port 84 of the direction control valve is fluidly connected to or in fluid communication with the first hydraulic motor conduit 88. At the same time, the second port 86 of the direction control valve is fluidly connected to or in fluid communication with the second hydraulic motor conduit 90. The first and second ports 84 and 86 of the direction control valve 22 are not, however, fluidly connected to or in fluid communication with each other. Instead, the first port 84 is fluidly connected to or in fluid communication with the fluid inlet 34 of the direction control valve 22 through a passage 96 in the direction control valve. The second port 86 is fluidly connected to or in fluid communication with the fluid outlet 38 of the direction control valve 22 through a passage 98 in the direction control valve.

In the first actuated position of the direction control valve 22, fluid from the pump 28 is received at the fluid inlet 34 of the direction control valve 22, conducted through the passage 96 in the direction control valve 22, discharged through the first port 84 into the first hydraulic motor conduit 88, and is delivered to the first chamber portion 52 of the hydraulic motor 24. Similarly, in the first actuated position of the direction control valve 22, fluid from the second chamber portion 54 of the hydraulic motor 24 is discharged into the second hydraulic motor conduit 90, received at the second port 86 of the direction control valve 22, conducted through the passage 98 in the direction control valve 22, and discharged from the fluid outlet 38 of the direction control valve into the fluid return conduit 39 for return to the reservoir 30. The pressure of the fluid delivered to the first chamber portion 52 of the hydraulic motor 24 helps or assists the piston to move to the right, as viewed in FIG. 1, thereby assisting an operator of the vehicle (not shown) to cause the steerable vehicle wheels 18 and 20 to turn in one rotational direction in response to rotation of the vehicle steering wheel 14 by the operator.

When the direction control valve 22 is in a second actuated position (not shown), the first port 84 of the direction control valve is fluidly connected to or in fluid communication with the second hydraulic motor conduit 90. At the same time, the second port 86 of the direction control valve is fluidly connected to or in fluid communication with the first hydraulic motor conduit 88. The first and second ports 84 and 86 of the direction control valve 22 are not, however, fluidly connected to or in fluid communication with each other. Instead, the first port 84 is fluidly connected to or in fluid communication with the fluid outlet 38 of the direction control valve 22 through a passage 102 in the direction control valve. The second port 86 is fluidly connected to or in fluid communication with the fluid inlet 34 of the direction control valve 22 through a passage 100 in the direction control valve.

In the second actuated position of the direction control valve 22, fluid from the pump 28 is received at the fluid inlet 34 of the direction control valve 22, conducted through the passage 100 in the direction control valve 22, discharged through the second port 86 into the second hydraulic motor conduit 90, and delivered to the second chamber portion 54 of the hydraulic motor 24. Similarly, in the second actuated position of the direction control valve 22, fluid from the first chamber portion 52 of the hydraulic motor 24 is discharged into the first hydraulic motor conduit 88, received at the first port 84 of the direction control valve 22, conducted through the passage 102 in the direction control valve 22, and discharged from the fluid outlet 38 of the direction control valve into the fluid return conduit 39 for return to the reservoir 30. The pressure of the fluid delivered to the second chamber portion 54 of the hydraulic motor 24 helps or assists the piston to move to the left, as viewed in FIG. 1, thereby assisting an operator of the vehicle (not shown) to cause the steerable vehicle wheels 18 and 20 to turn in a rotational direction opposite the rotational direct in which the steerable wheels turn when the direction control valve is in its first actuated position.

As shown schematically in FIG. 1, the direction control valve 22 includes a valve housing 104 and a valve spool 106 that is movable lengthwise in the housing. A first coil spring 107 disposed at a left or first end of the valve spool 106 resiliently biases the valve spool in one lengthwise direction (to the right, as viewed in FIG. 1) in the valve housing 104. A second coil spring 109 disposed at the opposite, right or second end of the valve spool 106 resiliently biases the valve spool in an opposite lengthwise direction (to the left, as viewed in FIG. 1) in the valve housing 104. The valve spool 106 is thus resiliently biased by the first and second coil springs 107 and 109 to its neutral position in which the valve spool directs fluid from the pump 28 back to the reservoir 30.

Also adjacent the first end of the valve spool 106, a first electrically operable valve actuator 108, such as a solenoid, operates to move the valve spool in one of two opposite lengthwise directions (for example, to the left, as viewed in FIG. 1) in the valve housing 104 against the bias of the left or first coil spring 107. Adjacent the second end of the valve spool 106, a second electrically operable valve actuator 110, such as a solenoid, operates to move the valve spool in the other of the two opposite lengthwise directions (for example, to the right, as viewed in FIG. 1) in the valve housing 104 against the bias of the right or second coil spring 109. The valve spool 106 may thus be operated by the valve actuators 108 and 110 to one or the other of the first and second actuated positions. The valve spool 106 is operated such that it moves either fully to the first actuated position or fully to the second actuated position. If neither of the valve actuators 108 and 110 is actuated or operated, the first and second coil springs 107 and 109 cause the valve spool 106 to assume its neutral position.

The first and second valve actuators 108 and 110 and the first and second coil springs 107 and 109 comprise four components of the direction control apparatus 40 that includes the direction control valve 22. The direction control apparatus 40 also comprises a torque sensor 112 and a rotational position sensor 114 mounted on or otherwise operatively connected to the steering column assembly 26 and thus to the vehicle steering wheel 14.

The torque sensor 112 and the rotational position sensor 114 also comprise two components of a pressure control apparatus 41. The pressure control apparatus 41 further includes a first pressure sensor 116 mounted in or otherwise operatively connected with the first chamber portion 52 of the hydraulic motor 24 and a second pressure sensor 118 mounted in or otherwise operatively connected with the second chamber portion 54 of the hydraulic motor 24.

An electrical line 120 electrically connects the torque sensor 112 to a processor or controller 130, which is a component of both the direction control apparatus 40 and the pressure control apparatus 41. An electrical line 122 electrically connects the rotational position sensor 114 to the controller 130. An electrical line 124 electrically connects the first pressure sensor 116 to the controller 130. An electrical line 126 electrically connects the second pressure sensor 118 to the controller 130. An electrical line 128 electrically connects the first valve actuator 108 to the controller 130. An electrical line 132 electrically connects the second valve actuator 110 to the controller 130.

The controller 130 is also electrically connected, via an electrical line 134, to a speed and/or displacement control device 136 that controls the speed and/or displacement of the pump 28 and that is a component of the pressure control apparatus 41. For example, the pump 28 may be an electric pump driven by an electric motor. The speed of the electric motor and thus the speed of the pump 28 may thus be controlled by the control device 136.

In operation of the hydraulically assisted steering system 10, when (a) the vehicle steering wheel 14 is positioned such that the steerable vehicle wheels 18 and 20 are in a straight ahead condition and (b) the vehicle operator is not turning the vehicle steering wheel and, therefore, not applying any torque to the steering wheel, the rotational position sensor 114 and the torque sensor 112 provide corresponding electrical signals to the controller 130 via the electrical lines 122 and 120, respectively. The controller 130, in response to the signals from the rotational position sensor 114 and the torque sensor 112, does not actuate either the first or the second valve actuator 108, 110. The first and second coil springs 107 and 109 thus maintain the direction control valve 22 in its neutral position. Consequently, hydraulic fluid supplied by the pump 28 to the direction control valve 22 flows through the passage 94 in the direction control valve to the fluid return conduit 39 and thus to the reservoir 30. As no hydraulic fluid is supplied to the hydraulic motor 24, the piston 50 of the hydraulic motor does not move in or relative to the cylinder 46 in response to fluid pressure.

When the vehicle operator turns the vehicle steering wheel 14 to the left or the right from the position in which the steerable vehicle wheels 18 and 20 are in a straight ahead condition, the rotational position sensor 114 and the torque sensor 112 provide corresponding electrical signals to the controller 130 via the electrical lines 122 and 120, respectively. The controller 130, in response to the signals from the rotational position sensor 114 and the torque sensor 112, actuates either the first electrically operable valve actuator 108 or the second electrically operable valve actuator 110 depending upon the direction in which the vehicle steering wheel 14 is turned. The valve spool 106 of the direction control valve 22 responds to actuation of either the first electrically operable valve actuator 108 or the second electrically operable valve actuator 110 and moves to either the first or the second actuated position. Fluid delivered to the direction control valve 22 is then directed by the direction control valve 22 to either the first or the second chamber portion 52 or 54 of the hydraulic motor 24 in accordance with the actuated position of the direction control valve. The piston 50 moves either to the right or to the left, as viewed in FIG. 1, in response to rotation of the vehicle steering wheel 14, assisted by the pressure of fluid flowing into the first or the second chamber portion 52 or 54 of the hydraulic motor 24, while the fluid in the other of the first and second chamber portions is allowed to flow back to the reservoir 30 through the direction control valve 22. Axial movement of the piston 50 in the cylinder 46 causes movement of the sector gear 66 and the output shaft 68 and, through the linkage 70, the steerable vehicle wheels 18 and 20.

Although the position of the direction control valve 22 determines the direction in which the pressurized hydraulic fluid flows to the hydraulic motor 24 to assist the piston 50 to move in or relative to the cylinder 46 and, thus, to assist the steerable vehicle wheels 18 and 20 to turn, the amount of pressure applied to the piston and, thus, the amount of hydraulic power assistance provided to the vehicle operator to turn the steerable vehicle wheels is determined by the pump 28. In other words, because the direction control valve 22 has only three positions, hydraulic fluid pressure is applied to either the left side or the right side of the piston 50 at a level or amount determined by the speed and/or displacement of the pump 28 or is not applied at all to the piston.

If the vehicle operator desires a higher (or lower) level or amount of fluid pressure applied to the piston 50 of the hydraulic motor 24, for example, to assist the steerable vehicle wheels 18 and 20 to turn more quickly or more sharply, the additional pressure is supplied by adjusting the speed at which the pump 28 operates and/or the displacement of the pump. Thus, if the controller 130 determines, via look-up tables or computation, that signals from the torque sensor 112 and/or the rotational position sensor 114 indicate a requirement for increased hydraulic pressure, the controller sends an electrical signal to the speed and/or displacement control device 136 via the electrical line 134 to cause the operating speed and/or displacement of the pump 28 and, thus, the hydraulic pressure to increase. The controller 130 can monitor the pressure in the first and second chamber portions 52 and 54 via the first and second pressure sensors 116 and 118, respectively. The controller 130 may thus adjust the signal sent to the speed and/or displacement control device 136 based on the signals from the first and second pressure sensors 116 and 118 as required. In other words, the controller 130 may thus control and adjust or change one or both of pump speed and pump displacement.

As can be seen from the foregoing description, the hydraulically assisted steering system 10 provides separate control of the direction of hydraulic fluid flow and the pressure of the hydraulic fluid in the steering system. By eliminating the requirement to throttle fluid flow through a typical “open center” steering gear in order to control both the direction of hydraulic fluid flow and the amount of hydraulic fluid pressure using a single rotary control valve in a steering gear, the hydraulically assisted steering system 10 eliminates the energy losses associated with such throttling.

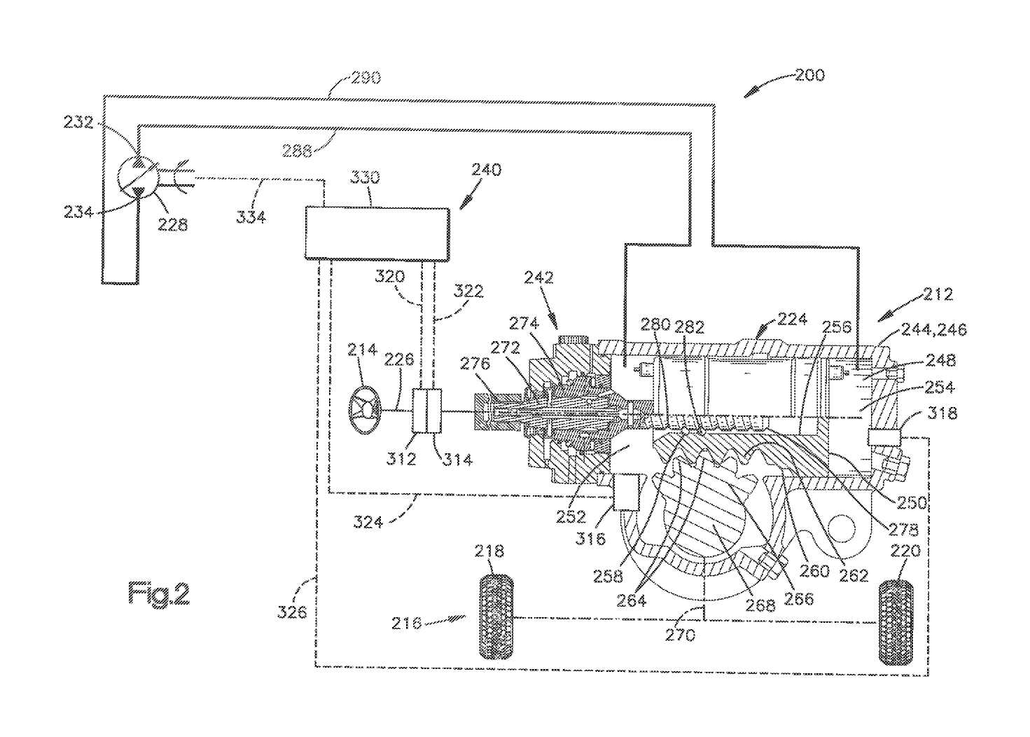

FIG. 2 illustrates a hydraulically assisted steering system 200 for a vehicle (not shown), in accordance with a second example of the present invention. The hydraulically assisted steering system 200 comprises a hydraulic power steering gear 212 operatively connected to a manually rotatable vehicle steering wheel 214. The steering gear 212 is also operatively connected to a set 216 of steerable vehicle wheels 218 and 220. The steering gear 212 includes a hydraulic actuator or hydraulic motor 224. The vehicle steering wheel 214 is connected to the steering gear 212 through a rotatable steering column assembly 226.

A pump 228 delivers pressurized hydraulic fluid to the steering gear 212. The pump 228 may be a variable speed pump and/or a variable displacement pump, such as a piston pump with a swash plate, and is also reversible. A first fluid outlet 232 of the pump 228 is fluidly connected to or in fluid communication with the steering gear 212 via a first hydraulic fluid conduit 288. A second fluid outlet 234 of the pump 228 is fluidly connected to or in fluid communication with the steering gear 212 via a second hydraulic fluid conduit 290. Because the pump 228 is reversible, the output of the pump can be directed to either the first fluid outlet 232 or the second fluid outlet 234. If the output of the pump 228 is being directed to the first fluid outlet 232, the second fluid outlet 234 can serve as a fluid inlet to the pump. Similarly, if the output of the pump 228 is being directed to the second fluid outlet 234, the first fluid outlet 232 can serve as a fluid inlet to the pump.

The steering gear 212 is an integral hydraulic power steering gear that incorporates the hydraulic motor 224. The steering gear 212 may or may not incorporate some or all of the structural or mechanical components of a rotary steering control valve 242. Whether the steering gear 212 includes all, some, or none of the structural or mechanical components of a rotary steering control valve 242, however, no fluid flows across or through the rotary steering control valve from the pump 228 to the hydraulic motor 224 or from the hydraulic motor to the pump. All fluid flow to and from the hydraulic motor 224 occurs through the first and second hydraulic fluid conduits 288 and 290, and any fluid flow that might otherwise occur between the hydraulic motor and the rotary steering control valve 242 is blocked. Thus, as will be explained in greater detail below, the flow path from the hydraulic pump 228 to the hydraulic motor 224 does not include or is free of the rotary steering control valve 242. As illustrated in FIG. 2, the steering gear 212 incorporates all of the components of a rotary steering control valve 242. The rotary steering control valve 242 is constructed as an open center valve.

The steering gear 212 includes a housing 244 that forms a hydraulic cylinder 246. The cylinder 246 defines an internal chamber 248 that receives a piston 250. The piston 250 divides the chamber 248 into a first chamber portion 252 and a second chamber portion 254. Together, the cylinder 246 and the piston 250 comprise the hydraulic motor 224.

The piston 250 includes an inner surface 256 that defines a bore extending axially into the piston from one end. The inner surface 256 includes a helical groove 258. The piston 250 also has an external surface 260 that includes a set of external teeth 262. The teeth 262 mesh with teeth 264 on a sector gear 266. The sector gear 266 is fixed to an output shaft 268, which extends outwardly from the housing 244. The output shaft 268 is connected to a pitman arm (not shown) which, in turn, is connected via a linkage 270 to the set 216 of steerable vehicle wheels 218 and 220 to steer the vehicle (not shown). As the piston 250 moves in the chamber 248, the output shaft 268 is rotated to operate the linkage 270, which turns the steerable vehicle wheels 218 and 220.

The rotary steering control valve 242 comprises first and second valve members. The first valve member comprises a rotatable valve core 272. The second valve member comprises a rotatable valve sleeve 274. The valve core 272 is located coaxially within the valve sleeve 274 and is supported by the valve sleeve for limited rotation relative to the valve sleeve. The valve core is formed in one piece with a rotatable input shaft 276 of the steering gear 212.

As is also known in the art, the valve sleeve 274 is partially received within the bore of the piston 250. An outer surface 278 of the valve sleeve 274 includes a helical groove 280. The helical groove 280 of the valve sleeve 274 and the helical groove 258 of the piston 250 receive balls 282, which both mechanically connect the valve sleeve and the piston and also permit the valve sleeve to rotate relative to the piston. As a result, rotational movement of the valve sleeve 274 relative to the piston 250 produces axial movement of the piston in the cylinder 246. Conversely, axial movement of the piston 250 in the cylinder 246 produces rotational movement of the valve sleeve 274 relative to the piston.

The rotary steering control valve 242 is actuated by the rotatable steering column assembly 226, which is connected to the input shaft 276 of the steering gear 212. The rotatable steering column assembly 226 is rotated by the vehicle steering wheel 214. As is known in the art, rotation of the vehicle steering wheel 214 is transmitted via the steering column assembly 226 to the rotary steering control valve 242 to cause relative rotation of the valve core 272 and the valve sleeve 274. When the valve core 272 is rotated relative to the valve sleeve 274, however, no hydraulic fluid is ported through grooves (not shown) and associated passages (not shown) in the valve core and valve sleeve to or from the first and second chamber portions 252 and 254. Stated differently, the rotary steering control valve 242 is thus not fluidly connected to or in fluid communication with the hydraulic motor 224.

One end portion (to the left, as viewed in FIG. 2) of the valve sleeve 274 includes first and second lugs (not shown) that are disposed in diametrically opposed cut-outs (not shown) in the valve core 272. After rotation of the valve core 272 through an angle of between 2° and 8° relative to the valve sleeve 274, in response to rotation of the vehicle steering wheel 214, the lugs of the valve sleeve 274 engage the cut-outs in the valve core to cause the valve sleeve to be rotated together with the valve core. Such rotation of the valve sleeve 274 together with the valve core 272 causes the piston 250 to move axially in the chamber 248 and, hence, allows for manual steering of the vehicle even if a loss in hydraulic fluid pressure has occurred.

The first hydraulic fluid conduit 288 extends from the first chamber portion 252 of the hydraulic motor 224 to the first fluid outlet 232 of the pump 228. The second hydraulic motor conduit 290 extends from the second chamber portion 254 of the hydraulic motor 224 to the second fluid outlet 234 of the pump 228.

A pump control apparatus 240 controls the operation of the pump 228 in a manner that will be described in greater detail below. The pump control apparatus 240 includes or functions as both a pressure control apparatus and a direction control apparatus. The pump control apparatus 240 comprises a torque sensor 312 and a rotational position sensor 314 mounted on or otherwise operatively connected to the steering column assembly 226 and thus to the vehicle steering wheel 214. The pump control apparatus 240 also comprises a first pressure sensor 316 mounted in or otherwise operatively connected with the first chamber portion 252 of the hydraulic motor 224 and a second pressure sensor 318 mounted in or otherwise operatively connected with the second chamber portion 254 of the hydraulic motor 224.

An electrical line 320 electrically connects the torque sensor 312 to a processor or controller 330. An electrical line 322 electrically connects the rotational position sensor 314 to the controller 330. An electrical line 324 electrically connects the first pressure sensor 316 to the controller 330. An electrical line 326 electrically connects the second pressure sensor 318 to the controller 330. The controller 330 is also electrically connected, via an electrical line 334, to the pump 228.

In operation of the hydraulically assisted steering system 200, when (a) the vehicle steering wheel 214 is positioned such that the steerable vehicle wheels 218 and 220 are in a straight ahead condition and (b) the vehicle operator is not turning the vehicle steering wheel and, therefore, not applying any torque to the steering wheel, the rotational position sensor 314 and the torque sensor 312 provide corresponding electrical signals to the controller 330 via the electrical lines 322 and 320, respectively. The controller 330, in response to the signals from the rotational position sensor 314 and the torque sensor 312, does not actuate the pump 228. Consequently, no hydraulic fluid is supplied to the hydraulic motor 224, and the piston 250 of the hydraulic motor does not move in or relative to the cylinder 246 in response to fluid pressure.

When the vehicle operator turns the vehicle steering wheel 214 to the left or to the right from the position in which the steerable vehicle wheels 218 and 220 are in a straight ahead condition, the rotational position sensor 314 and the torque sensor 312 provide corresponding electrical signals to the controller 330 via the electrical lines 322 and 320, respectively. The controller 330, in response to the signals from the rotational position sensor 314 and the torque sensor 312, functions as a component of a direction control apparatus and actuates the pump 228 to pump hydraulic fluid either to the first fluid outlet 232 or to the second fluid outlet 234 depending upon the direction in which the steering wheel is turned. Fluid is thus delivered either to the first hydraulic motor conduit 288 or to the second hydraulic motor conduit 290 and then either to the first chamber portion 252 or to the second chamber portion 254 of the hydraulic motor 224 in accordance with the direction of rotation of the vehicle steering wheel 214 and the direction of rotation of the pump 228. The piston 250 moves either to the right or to the left, as viewed in FIG. 2, in response to rotation of the vehicle steering wheel 214, assisted by the pressure of fluid flowing into the first or the second chamber portion 252 or 254 of the hydraulic motor 224, while the fluid in the other of the first and second chamber portions is allowed to flow back to the pump 228. Axial movement of the piston 250 in the cylinder 246 causes movement of the sector gear 266 and the output shaft 268 and, through the linkage 270, the steerable vehicle wheels 218 and 220.

Although the direction of rotation of the pump 228 determines the direction in which the pressurized hydraulic fluid will cause the piston 250 to move in or relative to the cylinder 246 and, thus, the direction in which the steerable vehicle wheels 218 and 220 are turned, the amount of pressure applied to the piston and, thus, the amount of hydraulic power assistance provided to the vehicle operator to turn the steerable vehicle wheels is determined by the displacement and/or the speed of the pump 228. In other words, if the vehicle operator desires a higher (or lower) level or amount of fluid pressure to be applied to the piston 250 of the hydraulic motor 224, for example, to cause the steerable vehicle wheels 218 and 220 to turn more quickly or more sharply, the additional pressure is supplied by adjusting the displacement and/or the speed of the pump 228. Thus, if the controller 330 determines, via look-up tables or computation, that signals from the torque sensor 312 and/or the rotational position sensor 314 indicate a requirement for increased hydraulic pressure, the controller sends an electrical signal to the pump 228 via the electrical line 334 to cause the speed and/or displacement of the pump 228 to increase, for example, by causing the position of the swash plate (not shown) to change such that the displacement of the pump 228 increases. The controller 330, in response to the signals from the rotational position sensor 314 and the torque sensor 312, effectively functions as a component of a pressure control apparatus, which also includes any other mechanism that helps to change the speed or the effective displacement of the pump 228, such as the swash plate (not shown) of the pump. The pressure control apparatus actuates the pump 228 to pump a greater or lesser volume of hydraulic fluid and thus apply a greater or lesser amount of fluid pressure to the piston 250 depending upon the speed at which the vehicle operator turns the vehicle steering wheel 214. The controller 330 can monitor the pressure in each of the first and second chamber portions 252 and 254 via the first and second pressure sensors 316 and 318. The controller 330 may thus adjust the signal sent to the pump 228 based on the signals from the first and second pressure sensors 316 and 318 as required to change the speed and/or the displacement of the pump 228, for example, by causing the position of the swash plate (not shown) to change. In other words, the controller 330 may thus control and adjust or change one or both of pump speed and pump displacement.

Although the hydraulically assisted steering systems 10 and 200 are shown using integral hydraulic power steering gears 12 and 212 incorporating rotary steering control valves 42 and 242 that are not fluidly connected to or in fluid communication with the hydraulic motors 24 and 224, the steering systems 10 and 200 may incorporate different steering gears that provide a mechanical connection between the respective vehicle steering wheels 14 and 214 and the associated steerable vehicle wheels 16, 20 and 216, 220, respectively. Such alternative steering gears may or may incorporate hydraulic motors, such as hydraulic motors 24 and 224. If such alternative steering gears do not incorporate hydraulic motors, the hydraulic motors would be provided in the steering systems 10 and 200 as separate units. Also, while the hydraulically assisted steering systems 10 and 200 are shown using both a rotational position sensor 114, 314 and a torque sensor 112, 312, it may be possible to use only a rotational position sensor or a torque sensor.

From the above description of the invention, those skilled in the art will perceive improvements, changes and modifications. Such improvements, changes and modifications within the skill of the art are intended to be covered by the appended claims.

Having described the invention, the following is claimed:

1. A hydraulically assisted steering system for turning steerable vehicle wheels comprising:
a steering gear operatively and mechanically connected both to a steering wheel and to a set of steerable vehicle wheels to effect turning of the steerable vehicle wheels in response to rotation of the steering wheel;
a hydraulic motor operatively connected to the set of steerable vehicle wheels to assist in turning of the steerable vehicle wheels;
a hydraulic pump fluidly connected to the hydraulic motor to deliver a flow of fluid to the hydraulic motor via a flow path from the hydraulic pump to the hydraulic motor, the flow path from the hydraulic pump to the hydraulic motor being free of any rotary steering control valve;
pressure control apparatus to monitor and adjust hydraulic fluid pressure in the hydraulic motor, the pressure control apparatus adjusting hydraulic fluid pressure in the hydraulic motor by controlling pump speed and/or pump displacement; and
direction control apparatus to control direction of hydraulic fluid flow to the hydraulic motor.

2. A hydraulically assisted steering system as set forth in claim 1, wherein the direction control apparatus includes a direction control valve having a first actuated position and a second actuated position.

3. A hydraulically assisted steering system as set forth in claim 2, wherein the hydraulic motor includes a piston received in a cylinder, the piston dividing a chamber inside the cylinder into a first chamber portion and a second chamber portion, the direction control valve directing hydraulic fluid to the first chamber portion when the direction control valve is in its first actuated position, the direction control valve directing hydraulic fluid to the second chamber portion when the direction control valve is in its second actuated position.

4. A hydraulically assisted steering system as set forth in claim 3, wherein the direction control apparatus includes at least one of a rotational position sensor and a torque sensor operatively connected to the steering wheel.

5. A hydraulically assisted steering system as set forth in claim 1, wherein the direction control apparatus includes a device to change a direction in which the pump operates to pump hydraulic fluid.

6. A hydraulically assisted steering system as set forth in claim 5, wherein the device to change the direction in which the pump operates is a controller.

7. A hydraulically assisted steering system as set forth in claim 6, wherein the direction control apparatus includes at least one of a rotational position sensor and a torque sensor operatively connected to the steering wheel.

8. A hydraulically assisted steering system as set forth in claim 1, wherein the pressure control apparatus includes a device to change displacement of the pump.

9. A hydraulically assisted steering system as set forth in claim 8, wherein the device to change displacement of the pump is a controller.

10. A hydraulically assisted steering system as set forth in claim 1, wherein the hydraulic motor includes a piston received in a cylinder, the piston dividing a chamber inside the cylinder into a first chamber portion and a second chamber portion, the direction control apparatus directing hydraulic fluid to at least one of the first chamber portion and the second chamber portion, the pressure control apparatus including a first pressure sensor operatively connected to the first chamber portion and a second pressure sensor operatively connected to the second chamber portion.
